(19) United States
(12) Patent Application Publication
(10) Pub. No.: US 2021/0195143 A1
(43) Pub. Date: Jun. 24, 2021

(54) Smart Refrigerator

(71) Applicant: GUNITECH CORP., Hsinchu County 307 (TW)

(72) Inventor: Ching-Kun Yu, Hsinchu County (TW)

(21) Appl. No.: 16/920,990

(22) Filed: Jul. 6, 2020

Related U.S. Application Data
(60) Provisional application No. 62/953,250, filed on Dec. 24, 2019.

(51) Int. Cl. H04N 7/18; G05B 15/02; H04N 5/225; H04M 1/725

(52) U.S. Cl. CPC H04N 7/183; G05B 15/02; H04N 5/23206; H04M 1/725; H04N 5/2253

(57) ABSTRACT

A smart refrigerator electrically connected to a smartphone is provided. The smart refrigerator comprises a body, at least one vibration sensor, at least one camera, a network interface card and a central processing unit. The body comprises at least one refrigerator door and a storage space. The at least one vibration sensor is connected to the body. The camera is disposed in the body to capture an image of foods inside the storage space. The network interface card is disposed in the body and electrically connected to the smartphone. The central processing unit is disposed in the body and electrically connected to the at least one vibration sensor, camera and network interface card. The network interface card sends the image to the smartphone when the at least one vibration sensor senses a vibration of the at least one refrigerator door.

### BACKGROUND OF THE INVENTION

### Field of the Invention

The present invention relates to smart refrigerators and, more particularly, to a smart refrigerator capable of allowing users to see food therein without the users' opening refrigerator doors.

### Description of the Prior Art

Refrigerators are domestic appliances for storing foods at a low temperature to prevent the foods from decaying. To inspect the foods stored in the refrigerators, users have to open refrigerator doors. However, opening the refrigerator doors inevitably releases cool air otherwise kept in the refrigerators and thus reduces the freshness of the foods stored therein, not to mention that additional electric power is consumed to restore the low internal temperature of the refrigerators.

Therefore, it is imperative to provide a refrigerator capable of allowing users to see food therein without the users' opening refrigerator doors.

### SUMMARY OF THE INVENTION

It is an objective of the present invention to provide a smart refrigerator capable of allowing users to see food therein without the users' opening refrigerator doors.

In order to achieve the above and other objectives, a smart refrigerator of the present invention is electrically connected to a smartphone. The smart refrigerator includes a body, at least one vibration sensor, at least one camera, a network interface card and a central processing unit. The body includes at least one refrigerator door and a storage space. The at least one vibration sensor is connected to the body. The at least one camera is disposed in the body and adapted to capture an image of foods inside the storage space. The network interface card is disposed in the body and electrically connected to the smartphone. The central processing unit is disposed in the body and electrically connected to the vibration sensor, the camera and the network interface card. The network interface card sends the image to the smartphone when the at least one vibration sensor senses a vibration of the at least one refrigerator door.

According to an embodiment of the present invention, the network interface card sends the image to the smartphone when the network interface card receives an image transfer request from the smartphone.

According to an embodiment of the present invention, the at least one vibration sensor is positioned on the at least one refrigerator door.

According to an embodiment of the present invention, the at least one camera is positioned on the at least one refrigerator door.

### BRIEF DESCRIPTION OF THE DRAWINGS

FIG. 1 is a schematic view of a smart refrigerator and a smartphone according to an embodiment of the present invention.

FIG. 2 is a schematic view of an image displayed on the smartphone according to an embodiment of the present invention.

FIG. 3 is a block diagram of the smart refrigerator and the smartphone according to an embodiment of the present invention.

### DETAILED DESCRIPTION OF THE EMBODIMENTS

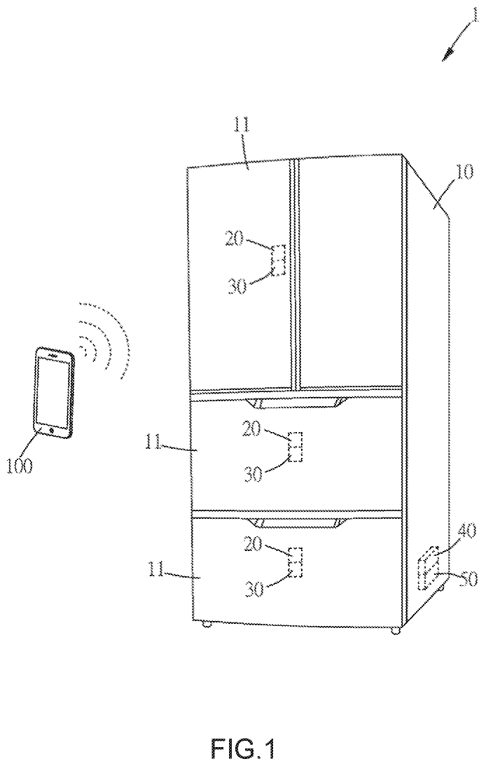

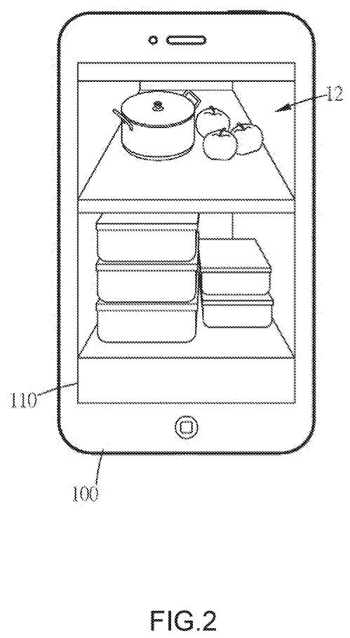

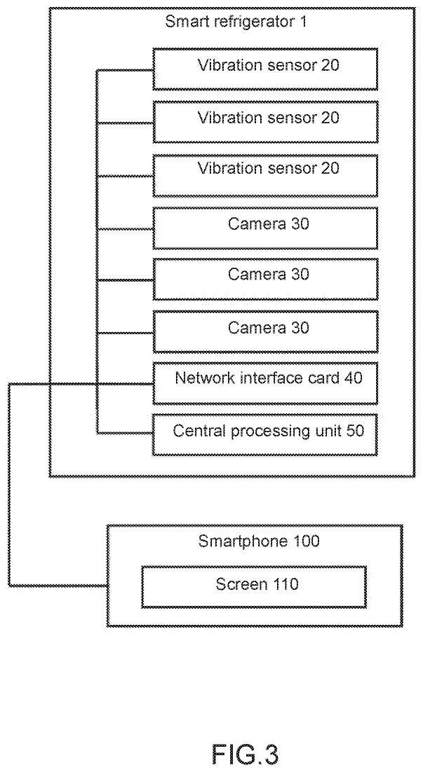

Please Refer to FIG. 1 to FIG. 3 about a smart refrigerator in an embodiment of the present invention. FIG. 1 is a schematic view of a smart refrigerator and a smartphone according to an embodiment of the present invention. FIG. 2 is a schematic view of an image displayed on the smartphone according to an embodiment of the present invention. FIG. 3 is a block diagram of the smart refrigerator and the smartphone according to an embodiment of the present invention.

As shown in FIG. 1 to FIG. 3, a smart refrigerator 1 for storing foods therein at a low temperature is provided in an embodiment of the present invention, and the smart refrigerator 1 enables users to see the foods therein without the users' opening refrigerator doors. The smart refrigerator 1 is electrically connected to a smartphone 100 by a network. The smartphone 100 has a screen 110. The screen 110 displays an image to be watched by the user. The smart refrigerator 1 includes a body 10, three vibration sensors 20, three cameras 30, a network interface card 40 and a central processing unit 50.

In an embodiment of the present invention, the body 10 is a cuboid casing which includes three refrigerator doors 11 and a storage space 12. The three refrigerator doors 11 close the storage space 12 to prevent cool air from leaking out of the smart refrigerator 1, The storage space 12 stores foods. However, the refrigerator doors 11 are not necessarily in the number of three, and thus their number is subject to changes as needed.

In an embodiment of the present invention, the three vibration sensors 20 are connected to the three refrigerator doors 11 of the body 10, respectively. The vibration sensors 20 sense whether their respective refrigerator doors 11 are shut with force and thereby vibrate. However, the vibration sensors 20 are not necessarily in the number of three, and thus their number may vary with the number of the refrigerator doors 11.

In an embodiment of the present invention, the three cameras 30 are disposed in the body 10 and positioned on the three refrigerator doors 11, respectively. The cameras 30 capture images of foods stored inside the storage space 12. The images thus captured include; for example; images indicative of the preservation state, quantity and types of foods stored inside the storage space 12. However, the cameras 30 are not necessarily in the number of three, and thus their number is subject to changes as needed. The cameras 30 are not necessarily restricted to be positioned on the refrigerator doors 11; in a variant embodiment; the cameras 30 are disposed at any position inside the body 10.

In an embodiment of the present invention, the network interface card 40 is disposed in the body 10 and electrically connected to the smartphone 100, The images captured of the foods stored inside the storage space 12 by the cameras 30 are transmitted by the network interface card 40 to the smartphone 100; thereby allowing users of the smartphone 100 to watch the images captured of the foods stored inside the storage space 12.

In an embodiment of the present invention, the central processing unit 50 is disposed in the body 10 and electrically connected to the three vibration sensors 20, the three cameras 30 and the network interface card 40. The central processing unit 50 controls and coordinates the operation of the three vibration sensors 20, the three cameras 30 and the network interface card 40.

In an embodiment of the present invention, when any one of the vibration sensors 20 senses a vibration of the refrigerator door 11 connected to the vibration sensor 20, the vibration sensor 20 which senses the vibration sends a vibration sensing message to the central processing unit 50. Then, the central processing unit 50 controls the camera 30 on the refrigerator door 11 which the vibration sensor 20 is connected to. The images of the foods in the storage space 12 captured by the camera 30 are sent to the network interface card 40. After that, the central processing unit 50 controllably causes the network interface card 40 to transmit the images captured by the camera 30 to the smartphone 100. Consequently, the users watch the images displayed on the screen 110 of the smartphone 100 to gain insight into the preservation state, quantity and types of foods stored inside the storage space 12. Therefore, the users can gain insight into the preservation state, quantity and types of foods stored in the smart refrigerator 1 without opening the refrigerator doors 11.

Furthermore, the mechanism for controllably causing the smart refrigerator 1 to send the captured images is not limited to the aforesaid embodiment. In a variant embodiment, the smartphone 100 is installed with software for controlling the smart refrigerator 1. The software generates an image transfer request and causes the smartphone 100 to send the image transfer request to the smart refrigerator 1. When the network interface card 40 receives the image transfer request from the smartphone 100, the central processing unit 50 controllably causes the cameras 30 to send the captured images to the network interface card 40. Next, the central processing unit 50 controllably causes the network interface card 40 to send the images captured by the cameras 30 to the smartphone 100. Therefore, the users can watch the images captured of the foods in the storage space 12 on the screen 110 of the smartphone 100.

The images captured of the foods stored in the smart refrigerator 1 are displayed on a smartphone and watched by the users; consequently, the users can gain insight into the preservation state, quantity and types of foods stored in the smart refrigerator 1 without opening the refrigerator doors thereof, so as to preclude leakage of cool air, reduction of food freshness, and extra power consumption.

What is claimed is:

1. A smart refrigerator electrically connected to a smartphone, the smart refrigerator comprising:
a body comprising at least one refrigerator door and a storage space;
at least one vibration sensor connected to the body;
at least one camera disposed in the body, and used for capturing an image inside the storage space;
a network interface card disposed in the body and electrically connected to the smartphone; and
a central processing unit disposed in the body and electrically connected to the at least one vibration sensor, the at least one camera and the network interface card;
wherein the network interface card sends the image to the smartphone when the at least one vibration sensor senses a vibration of the at least one refrigerator door.

2. The smart refrigerator of claim 1, wherein the network interface card sends the image to the smartphone when the network interface card receives an image transfer request from the smartphone.

3. The smart refrigerator of claim 2, wherein the at least one vibration sensor is positioned on the at least one refrigerator door.

4. The smart refrigerator of claim 3, wherein the at least one camera is positioned on the at least one refrigerator door.
